(19) United States
(12) Patent Application Publication
(10) Pub. No.: US 2024/0291007 A1
(43) Pub. Date: Aug. 29, 2024

(54) METHOD FOR DIAGNOSING A FUEL CELL SYSTEM, SYSTEM CONTROL DEVICE FOR IMPLEMENTING SUCH A METHOD, AND FUEL CELL SYSTEM INCLUDING SUCH A SYSTEM CONTROL DEVICE

(71) Applicant: Rolls-Royce Solutions GmbH, Friedrichshafen (DE)

(72) Inventors: Manuel Boog, Aulendorf (DE); Thomas Köser, Bermatingen (DE); Julian Nicolaas Bär, Meckenbeuren (DE)

(73) Assignee: Rolls-Royce Solutions GmbH, Friedrichshafen (DE)

(21) Appl. No.: 18/659,054

(22) Filed: May 9, 2024

Related U.S. Application Data
(63) Continuation of application No. PCT/EP2022/081023, filed on Nov. 7, 2022.

(30) Foreign Application Priority Data
Nov. 9, 2021 (DE) 10 2021 212 618.9
Nov. 7, 2022 (WO) PCT/EP2022/081023

(51) Int. Cl. H01M 8/04858; H01M 8/04537; H01M 8/04664; H01M 8/24; H01M 16/00

(52) U.S. Cl. CPC H01M 8/04932; H01M 8/04604; H01M 8/04671; H01M 8/24; H01M 16/006

(57) ABSTRACT

A method for diagnosing a fuel cell system, including the steps of: providing the fuel cell system includes at least two fuel cell modules, an electricity storage device, and a system control device; detecting an equipment output by the system control device; setting a predetermined load point on a first fuel cell module; assigning a first output to the predetermined load point; setting a second first output on the at least one second fuel cell module and a second output on the electricity storage device by the system control device, in such a way that a total output—as the sum of the outputs and the detected equipment output—that is detected is zero; determining a first operating value of the first fuel cell module at the predetermined load point; and determining, based on the determined first operating value, a state of the first fuel cell module.

### CROSS REFERENCE TO RELATED APPLICATIONS

This is a continuation of PCT application no. PCT/EP2022/081023, entitled “METHOD FOR DIAGNOSING A FUEL CELL SYSTEM, SYSTEM CONTROL DEVICE FOR IMPLEMENTING SUCH A METHOD, AND FUEL CELL SYSTEM COMPRISING SUCH A SYSTEM CONTROL DEVICE”, filed Nov. 7, 2022, which is incorporated herein by reference. PCT application no. PCT/EP2022/081023 claims priority to German patent application no. 10 2021 212 618.9, filed Nov. 9, 2021, which is incorporated herein by reference.

### BACKGROUND OF THE INVENTION

### 1. Field of the Invention

The present invention relates to fuel cell systems.

### 2. Description of the Related Art

Methods are known for diagnosing a fuel cell system with at least two fuel cell modules, wherein in each fuel cell module of the fuel cell system a state of the respective fuel cell module is determined in a decentralized manner by way of a respective decentralized control device. The disadvantage with this is that an exchange of information between the decentralized control devices of the fuel cell modules and thus a cross-comparison is not possible.

Moreover, an electric load is distributed to at least two fuel cell modules of the fuel cell system. A diagnosis of the fuel cell system is therefore dependent on the electric load. The disadvantage of this is that a variation of the load point, particularly of a fuel cell module, and therefore a comprehensive diagnosis of the fuel cell system, particularly during normal operation, is difficult to achieve.

What is needed in the art is a method for diagnosing a fuel cell system, a system control device for implementing such a method, and fuel cell system including such a system control device, wherein the aforementioned disadvantages are partially, optionally completely, eliminated.

### SUMMARY OF THE INVENTION

The present invention relates to a method for diagnosing a fuel cell system, a system control device for implementing such a method, and a fuel cell system having such a control device.

The present invention provides a method for diagnosing a fuel cell system that includes at least two fuel cell modules, at least one electricity storage device, and a system control device, wherein an equipment output is detected by the system control device. A predetermined load point is set on the first fuel cell module, wherein a first output is assigned to the predetermined load point. Moreover, a second first output on at least a second fuel cell module of the at least two fuel cell modules and a second output on the at least one electricity storage device are set by the system control device such that a total output as the sum of the plurality of outputs and of the detected equipment output is zero. Moreover, in particular subsequently, at least one first operating value of the first fuel cell module is determined at a predetermined load point, wherein a state of the first fuel cell module is determined on the basis of the at least one first operating value.

By way of the method, it is advantageously possible to determine the state of a fuel cell module, regardless of the detected equipment output. Moreover, any desired load point can advantageously be set at a fuel cell module, so that it is possible in particular to examine a complete range of the load points, in particular from low load to full load. Advantageously, the method also makes it possible to monitor the state and/or ageing behavior of the fuel cell system, in particular prior to a defect occurring, and in particular to maintain the fuel cell module and/or fuel cell system based on the state of a fuel cell module and/or the fuel cell system.

It is especially advantageous that the procedure for diagnosing the fuel cell system can be implemented during normal operation of the fuel cell system, so that uninterrupted operation of the fuel cell system can be ensured.

In one optional embodiment, the procedure is carried out autonomously, in particular automatically or automated, in particular without personnel costs, in particular as a self-diagnostic process. The process is carried out especially optionally, locally within the fuel cell system. Alternatively, the process is optionally carried out at least partially in an external computing device.

In one optional embodiment, the first operating value and thereby in particular the state of the first fuel cell module is determined in a stationary manner. For this purpose, the predetermined load point is specified. Subsequently, a transient phase of the fuel cell system optionally occurs in order to set the predetermined load point before the first operating value is determined. In addition, the predetermined load point is optionally kept constant, optionally almost constant, during the determination of the first operating value—in particular with a deviation of no more than 10%, optionally no more than 5%.

Furthermore, a diagnosis of a fuel cell module and/or the fuel cell system and optionally a cross-comparison between a plurality of cell modules at system level takes place.

In the context of the present technical teaching, the output is contemplated by considering the direction of flow of the electrical energy. In particular, a positive output of a component is an output emitted by the component under consideration—in particular by a fuel cell module of the plurality of fuel cell modules, the electricity storage device, or an external system-whereby the component under consideration emits energy. A negative output of the component is in particular an output which is produced at the component—in particular the electricity storage device and the external system-whereby the component absorbs energy.

In particular, at least one electricity storage device is designed as an interruption-free power supply.

The at least one electricity storage device optionally has at least one electricity storage element. The at least one electricity storage device optionally also has at least one inverter which is optionally designed to convert direct current to alternating current and/or to convert alternating current to direct current. Alternatively, or additionally, the inverter is optionally designed as a DC voltage converter, in particular as a step-up or step-down converter.

Alternatively, or additionally, the inverter is optionally designed to convert a first alternating voltage with a first amplitude and a first frequency into a second alternating voltage with a second amplitude and a second frequency, wherein the first amplitude and the second amplitude and/or are the first frequency and the second frequency are different.

The at least one electricity storage element is optionally designed as a battery. Alternatively, or additionally, the at least one electricity storage element is designed as a capacitor or as an ultra-capacitor.

In the context of the present technical teaching, the at least two fuel cell modules are designed for the conversion of chemical energy into electrical energy, optionally by oxidation of a fuel, especially hydrogen. Thus, the at least two fuel cell modules are designed as energy sources. The electrical energy is optionally transmitted as direct current from the at least two fuel cell modules, in particular to the electricity storage device.

In the context of the present technical teaching, the equipment output is an output that is requested in total from the fuel cell system by all external systems connected to the fuel cell system or which is transmitted to the fuel cell system by all external systems connected to the fuel cell system. Alternatively, the detected equipment output is zero, so that no output is requested from the fuel cell system or transmitted to the fuel cell system.

In one optional design, exactly one external system is connected with the fuel cell system, so that the detected equipment output is determined by exactly one external system. Alternatively, a plurality of external systems is optionally connected with the fuel cell system, so that the detected equipment output is determined by the plurality of external systems as the sum of individual equipment outputs of the individual external systems. The individual equipment outputs can therein be individually positive or negative respectively.

In one optional design, the at least one external system is selected from a group consisting of a computing center, a hospital, an industrial plant, an internal combustion engine with a generator that is operatively connected with the combustion engine, a gas turbine with a generator that is operatively connected with the gas turbine, and a plant for provision of renewable energy, in particular a photovoltaic plant and/or a wind power plant. In particular, the computing center, the hospital, and the industrial plant are optionally designed as energy sinks. Furthermore, the internal combustion engine with the operatively connected generator, the gas turbine with the operatively connected generator and the plant for the provision of renewable energy are in particular optionally designed as energy sinks and are optionally equipped to transmit electrical energy to the fuel cell system, in particular to the electricity storage device.

In another optional design, the fuel cell modules each have at least one fuel cell stack, optionally a plurality of fuel cell stacks, a module control device and a module supply device. The module supply device has, in particular, a fuel supply line, an oxidizing agent supply line, an exhaust air outlet, a coolant line and an energy transmission device. The module control device is optionally operatively connected with the module supply device and is designed for control of the latter. In addition, the module control device is optionally operatively connected with the system control device. Alternatively, or additionally, the module control device is designed in particular to set the predetermined load point of the associated fuel cell module.

The at least two fuel cell modules and the at least one electricity storage device are optionally connected with each other in such a way that an exchange of energy, in particular electric energy, can occur. In particular, the electric energy provided by the at least one fuel cell module can be transmitted for storage to the at least one electricity storage device.

According to a further development of the present invention, it is intended that the at least one first operating value is selected from a group consisting of a current strength-voltage value pair, which is determined in particular as the value of a current strength-voltage characteristic curve, a temperature, a volume flow, a mass flow, a pressure, a speed of a turbocharger, a regeneration state of the first fuel cell module, an electrical conductivity of a coolant used to cool the first fuel cell module, a degree of efficiency of the first fuel cell module and a fuel concentration, in particular a hydrogen concentration, in an exhaust air of the first fuel cell module.

The temperature is selected in particular from a group consisting of a fuel temperature, in particular a hydrogen temperature, an oxidant temperature, in particular an oxygen temperature, an exhaust air temperature, in particular a water vapor temperature, and a coolant temperature of the first fuel cell module.

The volume flow is selected in particular from a group consisting of a fuel volume flow, in particular a hydrogen volume flow, an oxidant volume flow, in particular an oxygen volume flow, an exhaust air volume flow, in particular a water vapor volume flow, and a coolant volume flow of the first fuel cell module.

The mass flow is selected in particular from a group consisting of a fuel mass flow, in particular a hydrogen mass flow, an oxidant mass flow, in particular an oxygen mass flow, an exhaust air mass flow, in particular a water vapor mass flow, and a coolant mass flow of the first fuel cell module.

The pressure is selected in particular from a group consisting of a fuel pressure, in particular a hydrogen pressure, an oxidant pressure, in particular an oxygen pressure, an exhaust air pressure, in particular a water vapor pressure, and a coolant pressure of the first fuel cell module.

According to a further development of the present invention, it is intended that for a plurality of predetermined load points, a plurality of states of the first fuel cell module will be determined stationary or quasi-stationary or dynamic.

In particular, a quasi-stationary determination of the plurality of states for the plurality of predetermined load points is realized by setting the plurality of predetermined load points chronologically one after the other in such a way that a stationary or at least approximately stationary determination of the respective state of the fuel cell module is possible for each predetermined load point of the plurality of predetermined load points.

Advantageously, a quasi-stationary current strength-voltage characteristic curve can indicate a malfunction of the examined fuel cell module, especially of the first fuel cell module.

Advantageously, the fuel cell system is dynamically excited by a dynamic sequence of the plurality of predetermined load points and thus a dynamic determination of the plurality of states of the respective fuel cell module. This makes it advantageously possible to determine a reaction of the fuel cell system to a load change, in particular a transmission behavior of the fuel cell system, especially of the first fuel cell module of at least two fuel cell modules. In particular, a step response of a quantity selected from a group consisting of the voltage of the fuel cell system, the current strength of the fuel cell system, a temperature, a volume flow, a mass flow, a pressure and a speed of a turbocharger is considered to determine the transmission behavior.

The temperature is selected in particular from a group consisting of a fuel temperature, in particular a hydrogen temperature, an oxidant temperature, in particular an oxygen temperature, an exhaust air temperature, in particular a water vapor temperature, and a coolant temperature of the first fuel cell module.

The volume flow is selected in particular from a group consisting of a fuel volume flow, in particular a hydrogen volume flow, an oxidant volume flow, in particular an oxygen volume flow, an exhaust air volume flow, in particular a water vapor volume flow, and a coolant volume flow of the first fuel cell module.

The mass flow is selected in particular from a group consisting of a fuel mass flow, in particular a hydrogen mass flow, an oxidant mass flow, in particular an oxygen mass flow, an exhaust air mass flow, in particular a water vapor mass flow and a coolant mass flow of the first fuel cell module.

The pressure is selected in particular from a group consisting of a fuel pressure, in particular a hydrogen pressure, an oxidant pressure, in particular an oxygen pressure, an exhaust air pressure, in particular a water vapor pressure, and a coolant pressure of the first fuel cell module.

According to a further development of the present invention, it is provided that the state of the first fuel cell module will be determined by comparing the determined first operating value of the first fuel cell module with a determined second operating value of the at least one second fuel cell module, wherein the state of the first fuel cell module is determined based on the comparison. Alternatively, or additionally, the state of the first fuel cell module is determined by comparing the determined first operating value of the first fuel cell module with a digital twin model of the first fuel cell module, whereby the state of the first fuel cell module is determined based on the comparison.

In one optional design, the first operating value of the first fuel cell module is compared with the second operating value of the second fuel cell module, whereby optionally the load points associated with the respective operating values are almost identical, so that a reliable comparison of the operating values is possible.

In another optional arrangement, the quasi-stationary current strength-voltage characteristic curve of the first fuel cell module is compared with a quasi-stationary current strength-voltage characteristic curve of the second fuel cell module. In particular, deviations in the respective temporal derivatives, in particular in the gradients of the current strength-voltage characteristic curves and/or in the curvatures of the current strength-voltage characteristic curves, indicate a defective fuel cell module.

According to a further development of the present invention, it is provided that the digital twin model of the first fuel cell module will be calculated on the basis of averaged, in particular historical, operating data of the fuel cell system and/or the first fuel cell module.

Optionally, the digital twin model is continuously updated on the basis of the averaged, especially historical operating data, especially over the entire service life of the fuel cell system. Alternatively, or additionally, the digital twin model is optionally further developed based on model-based fault identification in order to ensure the best possible fault isolation.

According to a further development of the present invention, it is provided that the plurality of predetermined load points form a chronological load curve. The chronological load curve is optionally composed of at least one function, selected from a step function, a rectangular function, a linear function and a sine function, and/or a superposition of at least two functions, in particular at least two functions selected from at least one step function, at least one rectangular function, at least one linear function and at least one sine function.

According to a further development of the present invention, it is provided that for a predetermined number of fuel cell modules, in particular for each fuel cell module including at least two fuel cell modules, at least one state, optionally a plurality of states, of the respective fuel cell module will be determined iteratively.

The present invention also provides a system control device to control a fuel cell system, wherein the system control device is arranged to perform a method according to the present invention or a method according to one or more of the previously described embodiments. The system control device is optionally designed as a computing device, especially optionally as a computer, or as a control unit, especially as a control unit of a fuel cell system. In the context of the system control device, there are in particular the advantages already explained in regard to the method.

The system control device is optionally arranged to be operatively connected to the at least two fuel cell modules and the at least one electricity storage device and is arranged to control them respectively. In particular, the system control device is optionally arranged to be operatively connected to the module control devices of the at least two fuel cell modules and is arranged for their respective control.

The present invention also provides a fuel cell system with at least two fuel cell modules, at least one electricity storage device and one system control device according to the present invention or one system control device according to one or several of the embodiments previously described. In connection with the fuel cell system, there are in particular the advantages that have already been explained in connection with the method and the system control device.

The system control device is optionally operatively connected to the at least two fuel cell modules and the at least one electricity storage device and is arranged for their respective control. In particular, the system control device is particularly optionally operatively connected to the module control device of the at least two fuel cell modules and is arranged for their respective control.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic illustration of a design example of a fuel cell system;

FIG. 2 is a flow chart of a first design example of the method for diagnosing the fuel cell system;

FIG. 3 is a flow chart of a second design example of the method for diagnosing the fuel cell system;

FIG. 4 is a flow chart of a third design example of the method for diagnosing the fuel cell system;

FIG. 5 is a flow chart of a fourth design example of the method for diagnosing the fuel cell system; and

FIG. 6 is a flow chart of a fifth design example of the method for diagnosing the fuel cell system.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

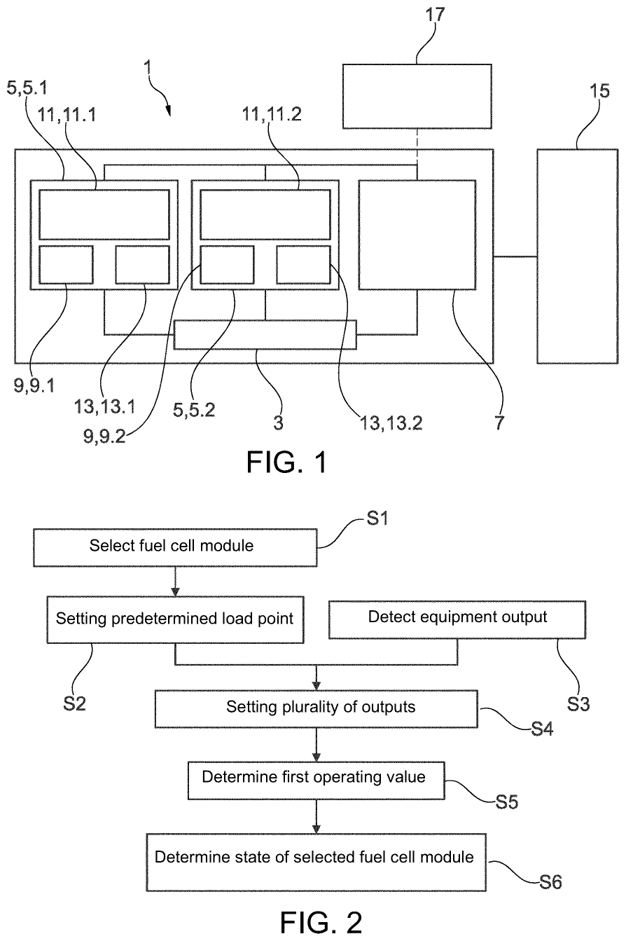

FIG. 1 shows a schematic representation of a design example of a fuel cell system 1. Fuel cell system 1 has a system control device 3, a first fuel cell module 5.1, a second fuel cell module 5.2 and a power storage device 7. Each fuel cell module 5 of the two fuel cell modules 5 respectively have a module control device 9, in particular first fuel cell module 5.1 having a first module control device 9.1 and second fuel cell module 5.2 having a second module control device 9.2, each having a fuel cell stack 11, in particular first fuel cell module 5.1 having a first fuel cell stack 11.1 and second fuel cell module 5.2 having a second fuel cell stack 11.2, and each having one module supply device 13, in particular first fuel cell module 5.1 having a first module supply device 13.1 and second fuel cell module 5.2 having a second module supply device 13.2.

System control device 3 is operatively connected—in a manner not explicitly shown—to fuel cell modules 5, in particular to module control devices 9, and electricity storage device 7 and is arranged for their respective control.

First module control device 9.1 is operatively connected—in a manner not explicitly shown—to first module supply device 13.1 and optionally to first fuel cell stack 11.1 and is arranged for their respective actuation.

Second module control device 9.2 is operatively connected—in a manner not explicitly shown—to second module supply device 13.2 and optionally to second fuel cell stack 11.2 and is arranged for their respective actuation.

Fuel cell system 1, in particular fuel cell modules 5, in particular module supply devices 13, is optionally connected to a fuel tank or a fuel line not shown here.

Alternatively, or additionally, fuel cell system 1 is optionally connected with at least one external system 15 for transmission of electric energy.

Optionally, fuel cell system 1, in particular electricity storage device 7, is connected to a device 17 for provision of renewable energy, in particular a photovoltaic system and/or a wind turbine, for the transmission of electric energy.

In addition, system control device 3 is arranged to optionally carry out a method for diagnosing fuel cell system 1 according to one or several of the design examples described below.

FIG. 2 is a flow chart of a first example of a method for diagnosing fuel cell system 1.

Identical and functionally identical elements are provided with the same identification in all drawings, so that reference is made to the previous description in each case.

In first step S1, one fuel cell module 5 of the at least two fuel cell modules 5, in particular first fuel cell module 5.1, is selected without limiting the commonality.

In second step S2, a predetermined load point is set on selected fuel cell module 5, in particular on first fuel cell module 5.1, wherein a first initial output is assigned to the predetermined load point.

In third step S3, an equipment output is detected. The equipment output is optionally specified by the at least one external system 15 or by a plurality of external systems 15.

Second step S2 and third step S3 are optionally carried out simultaneously. Alternatively, second step S2 is optionally carried out first, followed by third step S3. Alternatively, third step S3 is chronologically carried out first, followed subsequently by second step S2.

In fourth step S4, a second first output is set on at least one second fuel cell module 5 of the at least two fuel cell modules 5, in particular-without limiting the commonality-on second fuel cell module 5.2, and a second output is set on the at least one electric storage device 7 such that a total output as the sum of the plurality of outputs and the detected system power is zero.

In fifth step, S5, at least one initial operating value of selected fuel cell module 5, in particular first fuel cell module 5.1, is established at the predetermined load point. The at least one first operating value is optionally selected from a group consisting of a current strength-voltage value pair, which is determined in particular as the value of a current strength-voltage characteristic curve, a temperature, a volume flow, a mass flow, a pressure, a turbocharger speed, a regeneration state of selected fuel cell module 5, in particular of first fuel cell module 5.1, an electrical conductivity of a coolant used to cool selected fuel cell module 5, in particular first fuel cell module 5.1, an efficiency of selected fuel cell module 5, in particular first fuel cell module 5.1, and a hydrogen concentration in an exhaust air of selected fuel cell module 5, in particular first fuel cell module 5.1.

In sixth step, S6, a state of selected fuel cell module 5, in particular first fuel cell module 5.1, is determined on the basis of the at least one first operating value.

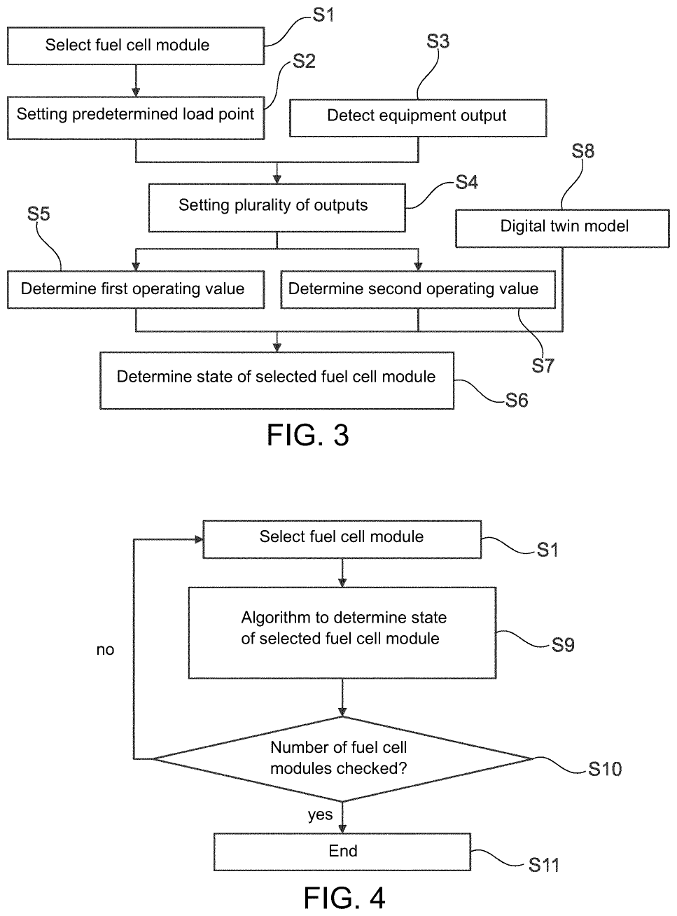

FIG. 3 is a flow chart of a second example of a method for diagnosing fuel cell system 1.

In addition to steps S1 to S6 of FIG. 2, at least one second operating value of the at least one second fuel cell module 5, in particular of second fuel cell module 5.2, is determined-without limiting the commonality—in seventh step S7, in particular prior to implementation of sixth step S6.

Alternatively, or in addition to seventh step S7, a digital twin model of selected fuel cell module 5, in particular of first fuel cell module 5.1, is provided in eighth step S8, in particular prior to seventh step S7. The digital twin model of selected fuel cell module 5, in particular of first fuel cell module 5.1, is optionally calculated-without limiting the commonality-on the basis of averaged, in particular historical, operating data.

In sixth step, S6, the state of selected fuel cell module 5, in particular first fuel cell module 5.1, is determined on the basis of a comparison of the at least one first operating value and the at least one second operating value. Alternatively, or additionally, the state of selected fuel cell module 5, in particular first fuel cell module 5.1, is determined in sixth step S6, based on a comparison of the at least one first operating value with the digital twin model.

FIG. 4 is a flow chart of a third example of the method for diagnosing fuel cell system 1.

In first step S1, a fuel cell module 5 of the at least two fuel cell modules 5 of fuel cell system 1 is selected analogous to the first example of FIG. 2 and the second example of FIG. 3.

In ninth step S9, the first example of the method for diagnosing fuel cell system 1 shown in FIG. 2, in particular steps S2 to S6, is optionally carried out. Alternatively, in the ninth step S9, the second example of the method shown in FIG. 3, in particular steps S2 to S7 and/or steps S2 to S8, is optionally performed.

In tenth step S10, it is checked whether at least one state of respective fuel cell module 5 has been determined for a predetermined number of fuel cell modules 5 of the at least two fuel cell modules 5 of fuel cell system 1, in particular for each fuel cell module 5 of the at least two fuel cell modules 5.

If, for the predetermined number of fuel cell modules 5—in particular for each fuel cell module 5 of the at least two fuel cell modules 5—at least one state of respective fuel cell module 5 was determined, the method is ended in eleventh step S11.

If the predetermined number has not yet been reached—in particular if at least one state for each fuel cell module 5 has not been determined-first step S1, ninth step S9 and tenth step S10 are repeated for a new fuel cell module 5 of the at least two fuel cell modules 5.

Optionally, at least one state of respective fuel cell module 5 is determined iteratively for each fuel cell module 5 of the at least two fuel cell modules 5.

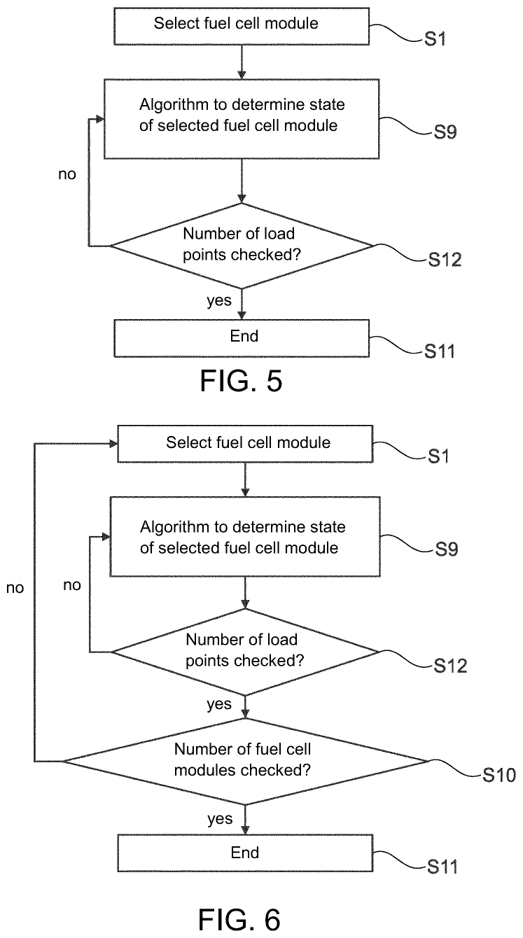

FIG. 5 is a flow chart of a fourth example of the method for diagnosing of fuel cell system 1.

The fourth example differs from the third example of FIG. 4 in that, after nineth step S9 it is checked in twelfth step S12 whether a state of selected fuel cell module 5 of the at least two fuel cell modules 5 from first step S1 has been determined for each predefined load point of a plurality of predefined load points.

If, for each predefined load point of the plurality of load points, a state of selected fuel cell module 5 was determined, the method is terminated in eleventh step S11.

If a state of selected fuel cell module 5 has not been determined for each predefined load point of the plurality of predefined load points, ninth step S9 and twelfth step S12 are performed again.

Optionally—in particular by way of the fourth example of the method-a state of selected fuel cell module 5 is determined respectively for the plurality of predetermined load points, stationary or quasi-stationary or dynamic.

In addition, the plurality of predetermined load points optionally create a chronological load curve. In particular, this chronological load curve is optionally composed of at least one function, selected from a step function, a rectangular function, a linear function, and a sine function, and/or a superposition of at least two such functions.

FIG. 6 is a flow chart of a fifth example of the method for diagnosis of fuel cell system 1.

The fifth example is optionally a combination of the third example of the method according to FIG. 4 and the fourth example of the method according to FIG. 5. Optionally, a state of respective fuel cell module 5 is determined in particular iteratively for the predetermined number of fuel cell modules 5, in particular for each fuel cell module 5 of the at least two fuel cell modules 5 of fuel cell system 1, for each predetermined load point of the plurality of predetermined load points.

In particular, in first step S1, a fuel cell module 5 of the at least two fuel cell modules 5 of fuel cell system 1 is selected, analogous to previous examples.

In ninth step S9, the first example of the procedure for diagnosing fuel cell system 1 according to FIG. 2, in particular steps S2 to S6, is optionally carried out. Alternatively, in ninth step S9, the second example of the method in FIG. 3, in particular steps S2 to S7 and/or steps S2 to S8, is optionally performed.

In twelfth step S12, it is checked whether a state of selected fuel cell module 5 has been determined for selected fuel cell module 5 of the at least two fuel cell modules 5 from first step S1 for each predefined load point of the plurality of predefined load points.

If a state of selected fuel cell module 5 has not been determined for each predefined load point of the plurality of predefined load points, ninth step S9 and twelfth step S12 are repeated.

If a state of selected fuel cell module 5 has been determined for each predefined load point of the plurality of predefined load points, it is checked in tenth step S10 whether at least one state of respective fuel cell module 5 has been determined for the predetermined number of fuel cell modules 5 of the at least two fuel cell modules 5 of fuel cell system 1, in particular for each fuel cell module 5 of the at least two fuel cell modules 5.

If at least one state of respective fuel cell module 5 has been determined for the predetermined number of fuel cell modules 5, in particular for each fuel cell module 5 of the at least two fuel cell modules 5, the procedure is terminated in eleventh step S11.

If the predetermined number has not yet been reached, in particular if at least one state has not been determined for each fuel cell module 5, first step S1, ninth step S9, twelfth step S12 and tenth step S10 are repeated for a new fuel cell module 5 of the at least two fuel cell modules 5.

Optionally, at least one additional example, selected from the examples of the method according to FIG. 2, FIG. 3, FIG. 4, FIG. 5 and FIG. 6, is repeated cyclically, in particular after a predefined operating period of fuel cell system 1.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for diagnosing a fuel cell system, the method comprising the steps of:
providing that the fuel cell system includes at least two fuel cell modules, at least one electricity storage device, and a system control device, the at least two fuel cell modules including a first fuel cell module and at least one second fuel cell module;
detecting an equipment output by the system control device;
setting a predetermined load point on the first fuel cell module;
assigning a first output to the predetermined load point;
setting a second first output on the at least one second fuel cell module and a second output on the at least one electricity storage device by the system control device, in such a way that a total output that is detected is zero, the total output being a sum of a plurality of outputs and the equipment output, the plurality of outputs including the first output, the second first output, and the second output;
determining at least one first operating value of the first fuel cell module at the predetermined load point; and
determining, based on the at least one first operating value that has been determined, a state of the first fuel cell module.

2. The method according to claim 1, wherein the at least one first operating value is selected from a group consisting of a current strength-voltage value pair, a temperature, a volume flow, a mass flow, a pressure, a speed of a turbocharger, a regeneration state of the first fuel cell module, an electrical conductivity of a coolant used to cool the first fuel cell module, a degree of efficiency of the first fuel cell module, and a hydrogen concentration in an exhaust air of the first fuel cell module.

3. The method according to claim 1, wherein for a plurality of the predetermined load point each, the state of the first fuel cell module is determined stationary, quasi-stationary, or dynamic.

4. The method according to claim 1, wherein the state of the first fuel cell module is determined in that the at least one first operating value of the first fuel cell module that has been determined is at least one of:
(a) compared with at least one determined second operating value of the at least one second fuel cell module; and
(b) compared with a digital twin model of the first fuel cell module,
wherein the state of the first fuel cell module is determined based on a comparison performed in at least one of (a) and (b).

5. The method according to claim 4, wherein the digital twin model of the first fuel cell module is calculated based on averaged operating data.

6. The method according to claim 1, wherein a plurality of the predetermined load point creates a chronological load curve.

7. The method according to claim 6, wherein the chronological load curve is at least one of: (a) composed of at least one function selected from a step function, a rectangular function, a linear function, and a sine function; and (b) a superposition of at least two functions.

8. The method according to claim 1, wherein, for a predetermined number of the at least two fuel cell modules, at least one state of a respective one of the at least two fuel cell modules is determined iteratively.

9. A system control device, comprising:
the system control device, which is configured for controlling a fuel cell system and for implementing a method for diagnosing the fuel cell system, the method including the steps of:
providing that the fuel cell system includes at least two fuel cell modules, at least one electricity storage device, and the system control device, the at least two fuel cell modules including a first fuel cell module and at least one second fuel cell module;
detecting an equipment output by the system control device;
setting a predetermined load point on the first fuel cell module;
assigning a first output to the predetermined load point;
setting a second first output on the at least one second fuel cell module and a second output on the at least one electricity storage device by the system control device, in such a way that a total output that is detected is zero, the total output being a sum of a plurality of outputs and the equipment output, the plurality of outputs including the first output, the second first output, and the second output;
determining at least one first operating value of the first fuel cell module at the predetermined load point; and
determining, based on the at least one first operating value that has been determined, a state of the first fuel cell module.

10. A fuel cell system, comprising:
at least two fuel cell modules;
at least one electricity storage device; and
a system control device, which is configured for controlling a fuel cell system and for implementing a method for diagnosing the fuel cell system, the method including the steps of:
providing that the fuel cell system includes the at least two fuel cell modules, the at least one electricity storage device, and the system control device, the at least two fuel cell modules including a first fuel cell module and at least one second fuel cell module;
detecting an equipment output by the system control device;
setting a predetermined load point on the first fuel cell module;
assigning a first output to the predetermined load point;
setting a second first output on the at least one second fuel cell module and a second output on the at least one electricity storage device by the system control device, in such a way that a total output that is detected is zero, the total output being a sum of a plurality of outputs and the equipment output, the plurality of outputs including the first output, the second first output, and the second output;
determining at least one first operating value of the first fuel cell module at the predetermined load point; and
determining, based on the at least one first operating value that has been determined, a state of the first fuel cell module.
